(19) United States
(12) Patent Application Publication
(10) Pub. No.: US 2007/0097147 A1
(43) Pub. Date: May 3, 2007

(54) Dynamic image editing system, the same apparatus and mobile device

(76) Inventors: Keisuke Inata, Ebina (JP); Hiroaki Ono, Fujisawa (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/260,181

(22) Filed: Oct. 28, 2005

(51) Int. Cl. G09G 5/00

(52) U.S. Cl. 345/619

(57) ABSTRACT

In a moving image editing system, when a recorded encoded image file is to be edited, an editing process or a decoding process for editing is executed for an encoded image file with a low process load recorded for editing or corresponding editing information, to reduce a consumption power of editing. By using editing information on the encoded image file for editing and correlation information representative of correlation between encoded image files for storage and for editing, editing information on the encoded image file for storage is generated from the editing information on the encoded image file for editing, to reduce an editing load of the encoded image file for storage.

### BACKGROUND OF THE INVENTION

1. Field of the Invention

The present invention relates to a dynamic or moving image editing system and apparatus for encoding a moving image and recording or editing it, and to a mobile device.

2. Description of the Related Art

If there are a plurality of encoded image files of the same moving image, subject encoded image files are usually edited directly. In order to reduce a process load of a still image editing work, an encoded image file having a low process load among a plurality of encoded files of the same still image is edited (refer to JP-A-05-324790).

According to this technique, by utilizing the relation between an original image in a first image file and an original image having a low process load in a second image file, respectively obtained by encoding the same still image, the editing process contents of the second image file are reflected upon the original image in the first image file.

If a subject image is a still image, the original image and an image obtained by encoding the original image are the same in terms of time, and does not have time continuity. Further, two images are characterized by having the same contents two-dimensionally. By utilizing this feature, editing contents of one image are reflected upon the other images.

However, if a subject image is a moving image, the image and an image obtained by encoding the original image have time continuity and correlation. One of the original image and an image obtained by encoding the original image respectively having different frame rates has an image and the other does not have an image, at a certain time. In the case of two types of moving images encoded by an MPEG scheme, the concept of a key image (I picture) appears as different from still images. One key image is inserted into a plurality of images, and the images other than the key image are encoded on the basis of key image information. On the other hand, the still image is encoded in the still image itself, and backward and forward images relative to time are not used.

### SUMMARY OF THE INVENTION

An object of this invention is to solve the above-described problems and reduce a load of an editing process.

A system is provided which comprises: a camera unit for acquiring a moving image and converting the moving image into a digital signal; an encoding unit for generating a first encoded image file, a second encoded image file and correlation information on the two files; a storage unit for storing the correlation information; a decoding unit for executing a decoding process of the first encoded image file and/or the second encoded image file; a monitor unit for displaying a decoded moving image; a user interface unit for inputting an editing command for the second encoded image file; an editing unit for generating editing information on the first encoded image file and/or the second encoded image file in accordance with the editing command; and a control unit for executing input/output control of the storage unit, wherein the editing unit generates editing information on the second encoded image file in accordance with the editing command from the user interface unit, generates editing information on the first encoded image file corresponding to the editing information on the second encoded image file in accordance with the correlation information stored in the storage unit, and executes an editing process for the first encoded image file in accordance with the editing information on the first encoded image file.

Other objects, features and advantages of the present invention will become apparent from the following description of embodiments of the present invention when read in connection with the accompanying drawings.

### BRIEF DESCRIPTION OF THE DRAWINGS

FIG. 1 shows a typical example of a moving image recording system embodying the present invention.

FIG. 2 is a diagram showing an example of the details of an encoding unit of the moving image recording system shown in FIG. 1.

FIG. 3 is a diagram showing another example of an editing unit of the moving image recording system shown in FIG. 1.

FIG. 4 shows a typical example illustrating recording of a moving image recording system embodying the present invention.

FIG. 5 shows a typical example illustrating editing information generation of a moving image recording system embodying the present invention.

FIG. 6 shows a typical example illustrating editing process confirmation of a moving image recording system embodying the present invention.

FIG. 7 shows a typical example illustrating editing execution of a moving image recording system embodying the present invention.

FIGS. 8A, 8B and 8C show typical examples illustrating correlation information of a moving image recording system embodying the present invention.

FIGS. 9A, 9B and 9C show typical examples illustrating a means for generating two types of encoded image files of a moving image recording system embodying the present invention.

FIG. 10 illustrates an example of an editing process for an encoded image file.

FIG. 11 shows a typical example of editing information of a moving image recording system embodying the present invention.

FIGS. 12A and 12B are flow charts illustrating user operations embodying the present invention.

### DETAILED DESCRIPTION OF THE EMBODIMENTS

Embodiments of the invention will be described with reference to the accompanying drawings. In the embodiments, a consumption power of moving image editing is reduced and a process load is reduced such as process speed-up, by using two types of moving images obtained from an original image.

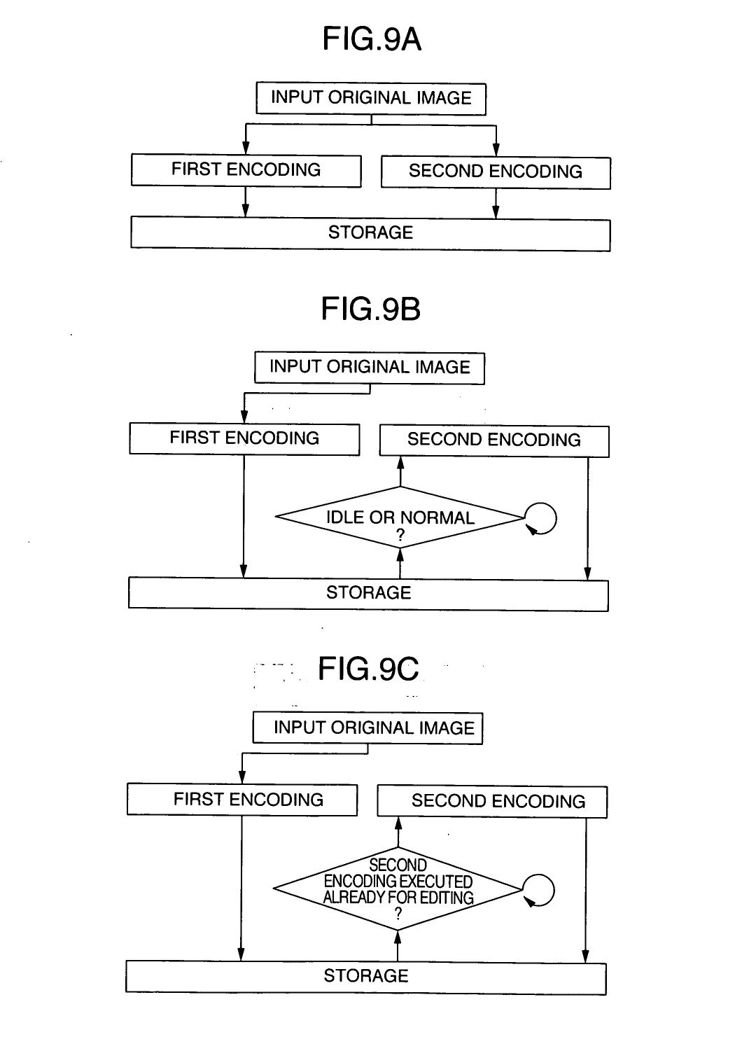

FIGS. 9A, 9B and 9C show timings of generating two types of encoded moving image files.

(1) In FIG. 9A, an input original image is encoded by using first and second encoding schemes at the same time, and the two encoded moving images are stored.

(2) In FIG. 9B, an input original image is encoded by using a first encoding scheme, and the obtained first encoded moving image is stored. Thereafter, the first encoded moving image is once read during a period while encoding is not executed (during an idle period), and encoded by a second encoding scheme, and the obtained second encoded moving image is stored.

(3) In FIG. 9C, an input original image is encoded by using a first encoding scheme, and the obtained first encoded moving image is stored. Thereafter, when editing is performed, the first encoded moving image is once read, and encoded by a second encoding scheme, and the obtained second encoded moving image is stored. If the encoded moving image encoded by the second encoded scheme is already stored when editing is performed, encoding is not performed but the already stored second encoded moving image encoded by the second encoding scheme is read and used for editing.

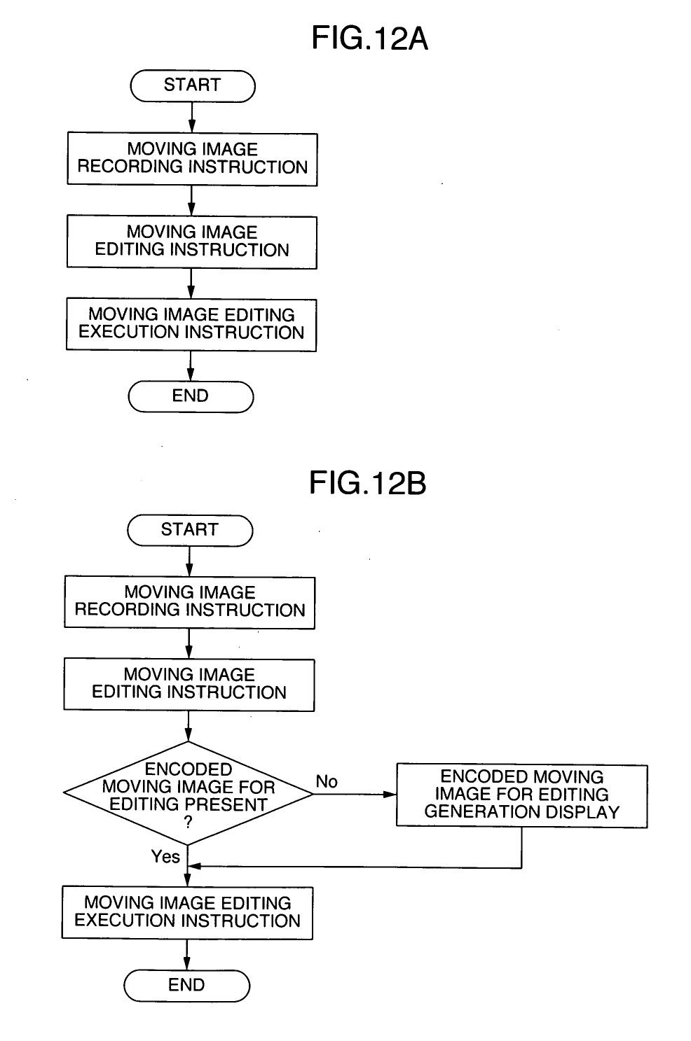

FIGS. 12A and 12B are flow charts illustrating user editing operations. The details of each operation will be later described.

FIG. 12A is a flow chart illustrating user recording and editing operations to be performed at an encoded image file generation timing shown in FIG. 9A. After first and second encoded moving images are recorded, a user decodes the second encoded moving image to perform an editing work while displaying it on a monitor.

FIG. 12B is a flow chart illustrating user recording and editing operations to be performed at an encoded image file generation timing shown in FIGS. 9B and 9C. If the second encoded moving image (moving image for editing) is already stored during the idle period or at first editing, a user can edit the moving image. If the second encoded moving image is still not generated, an indication “under preparation” is displayed and the second encoded moving image is generated from the first encoded moving image. After the second encoded image is generated, a user is notified of that editing is possible. If the second encoded moving image is being generated, no indication is displayed and a user can edit an already generated portion of the second encoded image. If a portion still not generated is to be edited, a user is notified of that the portion is being generated, to make the user temporarily stop editing.

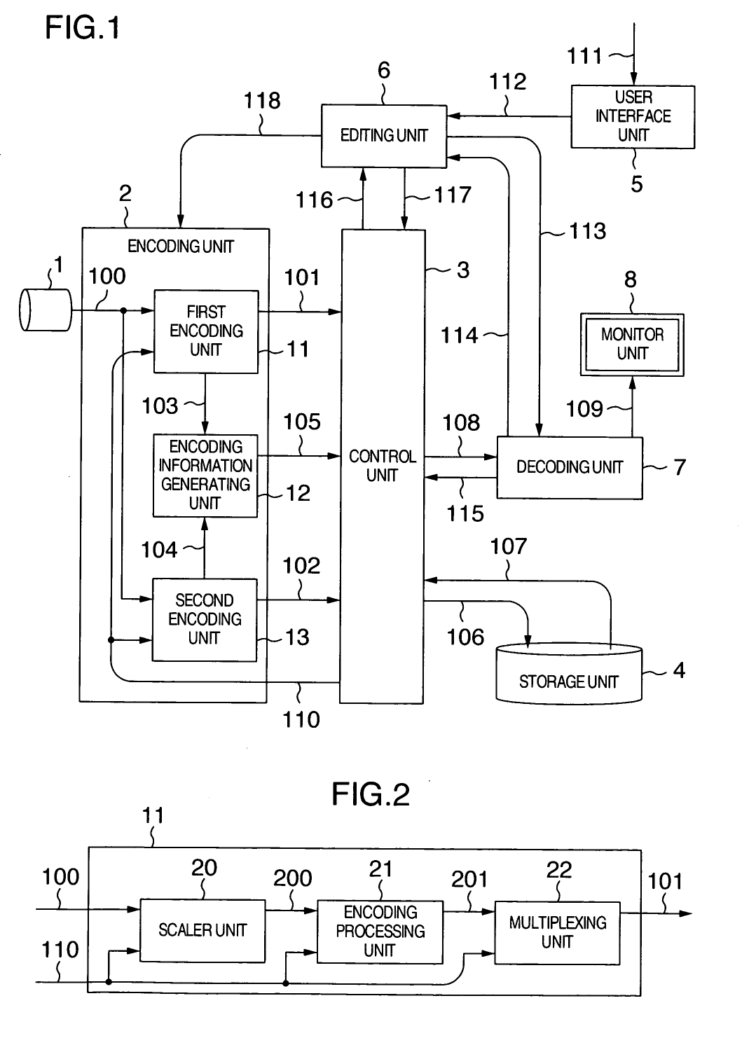

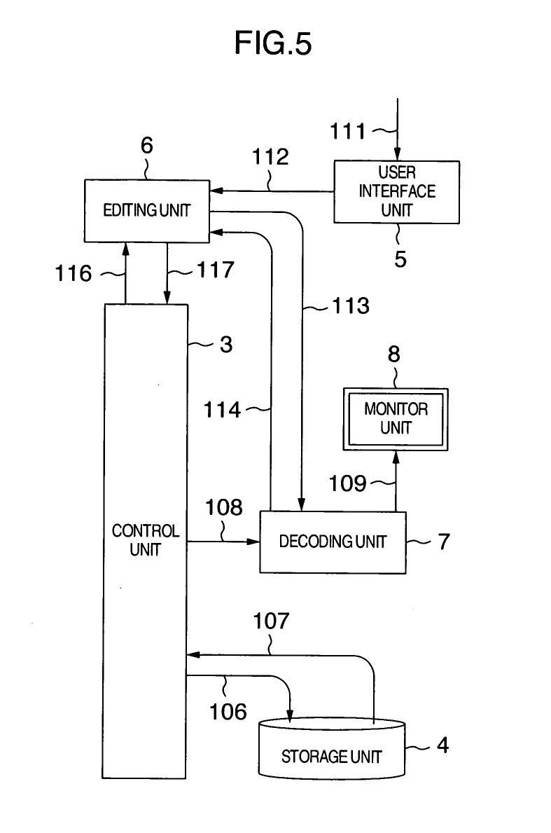

Next, an embodiment of a moving image editing system will be described. FIG. 1 shows a typical example of a moving image recording system. The operation of the moving image recording system shown in FIG. 1 is classified into four operations, 1) recording, 2) editing information generation, 3) editing processing confirmation and 4) editing execution. FIGS. 4, 5, 6 and 7 are diagrams illustrating examples of recording, editing information generation, editing processing confirmation and editing execution, respectively. In the moving image recording system shown in FIGS. 1, 4, 5, 6 and 7, an editing process for editing and a decoding process for displaying an editing screen are not executed directly for the first encoded image file recorded for storage, but are executed for the second encoded image file recorded for editing. The second encoded image file has an amount of the editing process and decoding process smaller than that of the first encoded image file, by changing a resolution, a frame rate, a bit rate and an encoding scheme.

As above, when the first encoded image file is to be edited, the second encoded image file having a suppressed process load of editing is edited and the decoding process is executed for displaying an editing screen. It is therefore possible to realize reduction in the process load and consumption power. For example, if editing is executed in the state of a limited power such as a battery, the editing process and decoding process are executed for the second encoded image file to indirectly generate editing information on the first encoded image file. In the state of no fear of consumption power because of using an external battery or the like, the editing process of the first encoded image file is actually executed by using the previously generated editing information, so that reduction in a consumption power can be realized. The following description will be made with reference to FIGS. 1, 4, 5, 6 and 7.

1) First, recording will be described with reference to FIG. 4.

A camera unit 1 is a block for receiving image information and converting it into digitalized image information 100. An encoding unit 2 is a block for receiving the image information 100 and generating two types of encoded image files: first and second encoded image files 101 and 102. The first encoded image file has a high image quality and is encoded for storage. The second encoded image file has a low image quality and is encoded for editing or transmission to mobile devices. The second encoded image file can reduce a consumption power by reducing the amount of the encoding process or decoding process. The first encoded image file 101 is generated by a first encoding unit 11, and the second encoded image file 102 is generated by a second encoding unit 13. Examples of an encoding scheme include MPEG-2, MPEG-4, H. 264 and the like. As one example of the encoding scheme, MPEG-2 is used for generating the first encoded image file and MPEG-4 is used for generating the second encoded image file. As another example, H. 264 is used for generating both the first and second encoded image files. In this case, a consumption power is lowered by reducing the amount of the encoding process or decoding process of the second encoded image file, by lowering a bit rate, a resolution, or a frame rate, or dropping a profile or not using an option tool group of the second encoded image file, more than those of the first encoded image file.

The encoding unit 2 has an encoded information generating unit 12 to generate correlation information 105. The correlation information 105 is information representative of correlation between the first and second encoded image files 101 and 102. Examples of the correlation information are GOP start positions, frame positions and the like. The correlation information 105 containing corresponding GOP start positions has the following meaning. For example, the correlation information 105 contains an information pair of a GOP start position information on the first encoded image file 101 and a GOP start position information on the second encoded image file 102 corresponding to the GOP start position information on the first encoded image file 101. The correlation information 105 is generated from information 103 obtained when the first encoded image file 101 is generated and information 104 obtained when the second encoded image file 102 is generated.

The first and second encoded image files 101 and 102 are stored in a storage unit 4 via a control unit 3. Reference numeral 106 shown in FIG. 1 represents a write path from the control unit 3 to the storage unit 4. The storage unit 4 may be a hard disk, an IC memory, or other recording media. The storage unit 4 may be mounted in the moving image recording system, may be mounted externally, may be connected to a network such as the Internet or may be connected wireless. A single storage unit may be used, or two or more storage units may be used, or a storage unit may be constituted of two or more types of media.

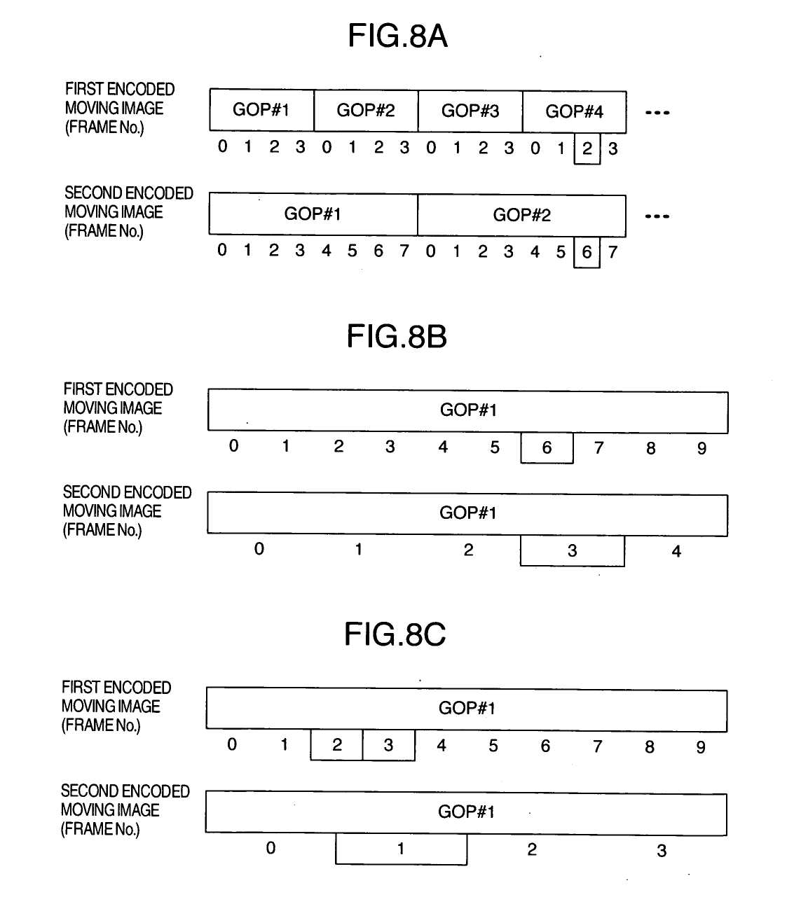

2) Next, editing information generation will be described with reference to FIGS. 5, 8A, 8B and 8C.

In this embodiment, a user inputs an editing command 111 to instruct editing. An example of the editing process is an editing process of cutting out a particular section of a file. In this case, examples of the editing command 111 by a user include a cut-out start position designation command, a cut-out end position designation command and a cut-out editing start command. Upon reception of each command, a user interface unit 5 delivers the command as an editing command 112 to an editing unit 6. The editing unit 6 reads the correlation information and editing information generated immediately before the editing process, from the storage unit 4, and writes or modifies editing information including the cut-out start position, cut-out end position and cut-out execution, as the editing information on the second encoded image file. The editing information is also written or modified as the editing information on the first encoded image file. For the editing information on the first encoded image file, the editing information corresponding to the contents of the editing information on the second encoded image file is written to or modified in the editing information on the first encoded image file. In this case, it is assumed that the correlation information contains information capable of identifying the frame positions of the first and second encoded image files.

FIGS. 8A, 8B and 8C are diagrams showing examples of the correlation information between the first and second encoded image files.

FIG. 8A shows an example of the same frame rate and different numbers of frames in GOP (Group of Picture). The number of frames in GOP is four for the first encoded moving image and eight for the second encoded moving image. By using this information as the correlation information, it can be understood for example that a frame corresponding to frame No. 6 in GOP#2 of the second encoded moving image corresponds to a frame corresponding to frame No. 2 in GOP#4 of the first encoded moving image.

FIG. 8B shows an example of different frame rates and the same GOP interval. A frame rate of the second encoded moving image is a half that of the first encoded moving image. The frame position of the first encoded moving image is at the same temporal position as that of the frame of the second encoding moving image. The number of frames in GOP is ten for the first encoded moving image and five for the second encoded moving image. By using this information as the correlation information, it can be understood for example that a frame corresponding to frame No. 3 in GOP#1 of the second encoded moving image corresponds to a frame corresponding to frame No. 6 in GOP#1 of the first encoded moving image.

FIG. 8C shows an example of different frame rates and the same GOP interval. A frame rate of the second encoded moving image is four tenth that of the first encoded moving image. There is a case wherein the frame position of the first encoded moving image is not at the same temporal position as that of the frame of the second encoding moving image. The number of frames in GOP is ten for the first encoded moving image and four for the second encoded moving image. By using this information as the correlation information, for example, a frame corresponding to frame No. 1 in GOP#1 of the second encoded moving image corresponds to a frame corresponding to frame No. 2 or 3 in GOP#1 of the first encoded moving image. It is necessary to select either No. 2 or 3. If frame No. 2 or 3 is not at a scene switch position, there arises no problem. However, if the scene switch position is just between two frames and an image is switched, it is necessary to select a frame having the same scene as that of frame No. 1 in GOP#1 of the second encoded moving image. To this end, frame positions of the first and second encoded moving images relative to the scene switch position are used as the correlation information. For example, the correlation information between frame No. 2 in GOP#1 of the first encoded moving image and frame No. 2 in GOP#1 of the second encoded moving image is used for the scene switch position. By using the correlation information, when frame No. 1 in GOP#1 of the second encoded moving image is selected, it can be understood that a corresponding frame position of the first encoded moving image is frame No. 2 in GOP#1.

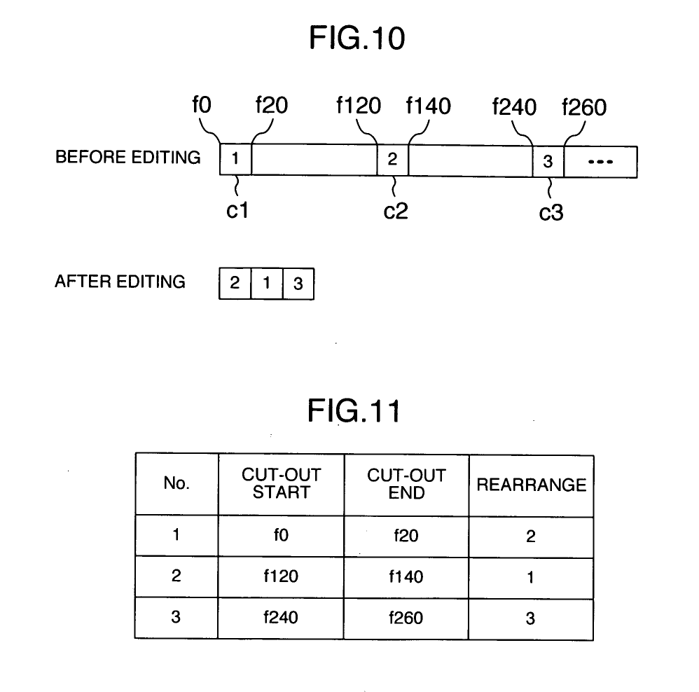

FIG. 10 shows an example of an editing process of an encoded image file. An upper portion shows the structure of an encoded image file before editing and a lower portion shows the structure of the encoded image file after editing. In this example, three positions are cut out from the encoded image file before editing and rearranged. In FIG. 10, c1, c2 and c3 represent three portions to be cut out. In FIG. 10, the cut-out start frame positions are represented by f0, f120 and f240, and the cut-out end frame positions are represented by f20, f140 and f260. After the cut-out is executed the portions are rearranged in the order of c2, c1 and c3 to complete editing. The encoded image file after editing is shown in the lower portion of FIG. 10.

FIG. 11 shows editing information obtained by the editing process shown in FIG. 10. For editing shown in FIG. 10 of the first encoded image file in the moving image recording system shown in FIG. 1, the first encoded image file 101 is not edited directly, but editing information such as shown in FIG. 11 is generated. The decoding process for the second encoded image file 102 is executed to display a screen for an editing work, on a monitor unit 8. Upon input of the editing command 111 by a user, the editing unit 6 generates first editing information on the second encoded image file. The editing information on the first encoded image file can be generated by using the correlation information 105. The editing information may include, in addition to cut-out and rearranging processes shown in FIG. 10, image processing such as rotation, fade-in, fade-out, inversion, monochrome, sepia, and mosaic, respectively of a partial moving image. Bit rate conversion or resolution conversion may be executed relative to the entirety of a file. The editing information constitutes a file containing all these information. A single format or plural formats may be used as the editing information format.

The user interface unit 5 is used for receiving the editing command 111 by a user to edit the recorded second encoded image file 102. A decoding unit 7 is a block for reading the second encoded image file 102 stored in the storage unit 4 from the storage unit 4 via the control unit 3 in response to a decoding encoding command 113 from the editing unit 6. Reference numeral 108 shown in FIG. 1 represents a read path from the storage unit 4 to the decoding unit 7. The decoding unit 7 is a block for further executing a decoding process of the read second encoded image file 102 and outputting decoded image information 109 to the monitor unit 8. Information obtained by the decoding process, i.e., the decoded information 114, may be supplied to the editing unit 6. The decoding unit 7 may display the information obtained by the decoding process as OSD (On Screen Display) on the monitor unit 8. The monitor unit 8 is a block for displaying the decoded image information 109.

The editing unit 6 is a block for reading correlation information or editing information from the storage unit 4 via the control unit 3 upon reception of the editing command 112. Reference numerals 107 and 116 shown in FIG. 1 represent a read path from the storage unit 4 to the editing unit 6. The correlation information is stored in the storage unit 4 from the encoding unit 2 via the control unit 3. The correlation information may be rewritten by the editing unit 6 in accordance with the editing command 112. The editing information corresponds to the collected editing contents for the second encoded image file 102. In executing new editing, the editing information may be generated by the encoding unit 2 or editing unit 6 during encoding, may be generated when the editing unit 6 receives the editing command 112 at the first time, or may be generated in accordance with the editing command 112 representative of new editing. The generated editing information is stored in the storage unit 4 via the control unit 3 after editing. If the editing process is to be executed at the second and subsequent times, the editing information generated immediately before the editing process or before the editing process is read from the storage unit 4 via the control unit 3 and the editing unit 6 executes a re-editing process. If there is editing information generated already before the editing process, a process similar to that for the new editing may be executed if a delete command of the editing information or the editing command 112 for new editing is received.

The editing unit 6 is also a block for executing a re-editing process of re-editing editing information on the second encoded image file 102, in accordance with the editing command 112. Re-editing is executed for editing information generated immediately before the editing process or before the editing process, or for newly generated editing information.

The editing unit 6 is also a block for generating the editing information on the first encoded image file 101 by using the editing information and correlation information 105 on the second encoded image file. The generated editing information on the first and second encoded image files is stored in the storage unit 4 via the control unit 3. Reference numerals 117 and 106 in FIG. 1 represent a write path from the editing unit 6 to the storage unit 4.

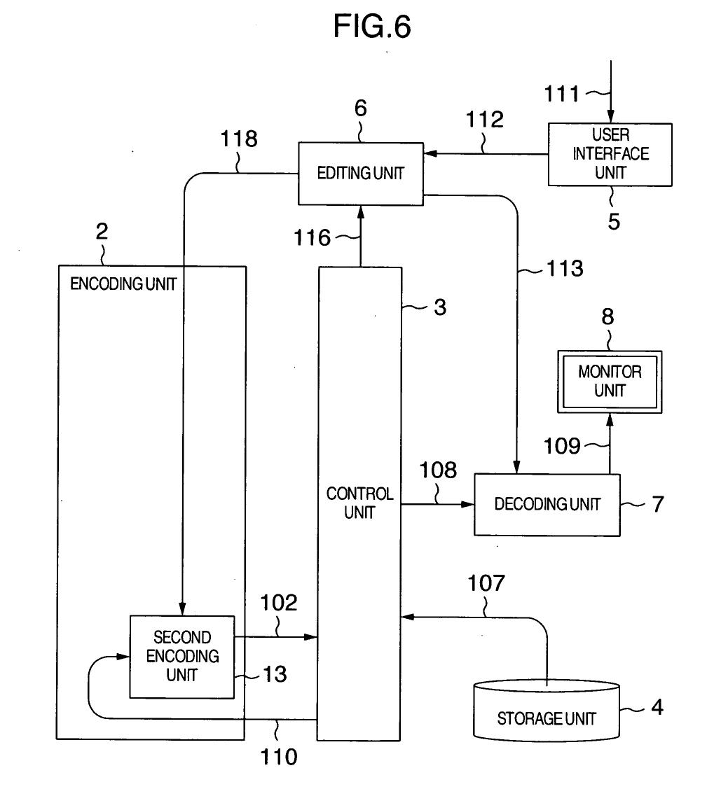

3) Next, editing process confirmation will be described with reference to FIG. 6.

The user interface unit 5 is used for receiving the editing command 111 by a user to reproduce the recorded second encoded image file 102. The editing command 111 by the user generates an editing command 112 in the user interface unit 5 which is supplied to the editing unit 6. The editing unit 6 issues a decoding editing command 113 to the decoding unit 7 to reproduce the second encoded image file 102 reflecting the editing information. The editing information is read from the storage unit 4 via the control unit 113. Upon reception of the decoding editing command 113 from the editing unit 6, the decoding unit 7 reads the second encoded image file from the storage unit 4 via the control unit 3 and executes the decoding process reflecting the decoding editing command 113 to output decoded image information 109 to the monitor unit 8. The monitor unit 8 is a block for displaying the decoded image information 109. If the editing process with re-encoding is to be executed, the editing unit 6 issues an encoding editing command 118 to the encoding unit 2. Examples of the editing process with re-encoding are bit rate conversion, resolution conversion and the like. The encoding unit 2 reads the second encoded image file 102 from the storage unit 4 via the control unit 3 and executes the re-encoding process in accordance with an editing instruction indicated by the encoding editing command 118. The re-encoded second encoded image file 102 is transferred to the storage unit 4 via the control unit 3, or reproduced by the decoding unit 7 to display it on the monitor unit 8.

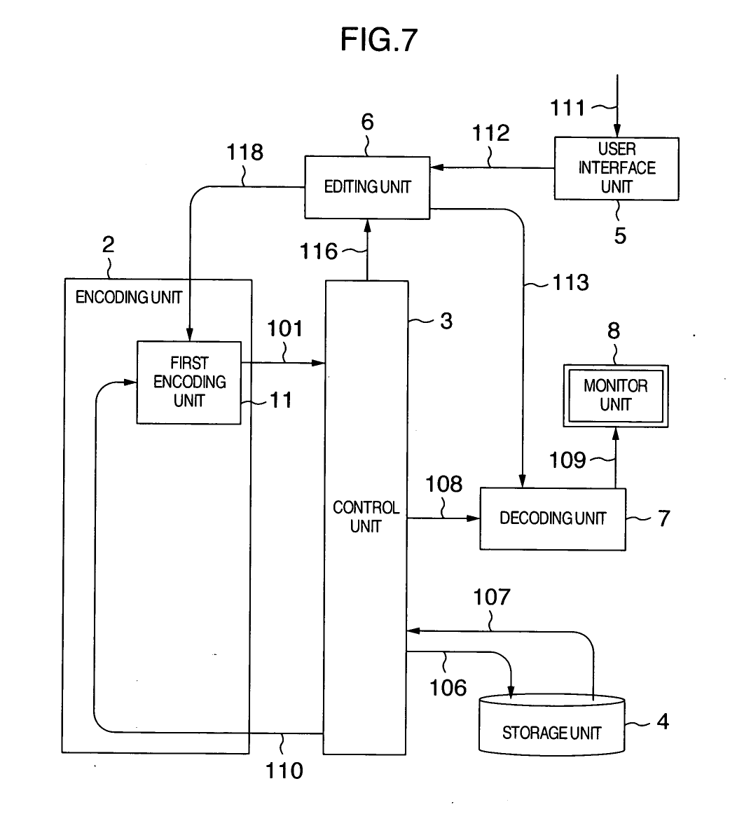

4) Next, editing execution will be described with reference to FIG. 7.

The user interface unit 5 is used for receiving the editing command 111 input externally by a user to reproduce the recorded first encoded image file 101. The editing command 111 input externally by the user generates the editing command 112 in the user interface unit 5 which is supplied to the editing unit 6. The editing unit 6 issues the decoding editing command 113 to the decoding unit 7 to reproduce the first encoded image file 101 reflecting the editing information. The editing information is read from the storage unit 4 via the control unit 3. Upon reception of the decoding editing command 113 from the editing unit 6, the decoding unit 7 reads the first encoded image file from the storage unit 4 via the control unit 3 and executes the decoding process reflecting the decoding editing command 113 to output decoded image information 109 to the monitor unit 8. The monitor unit 8 is a block for displaying the decoded image information 109. If the editing process with re-encoding is to be executed, the editing unit 6 issues the encoding editing command 118 to the encoding unit 2. Examples of the editing process with re-encoding are bit rate conversion, resolution conversion and the like. The encoding unit 2 reads the first encoded image file 101 from the storage unit 4 via the control unit 3 and executes the re-encoding process in accordance with an editing instruction indicated by the encoding editing command 118. The re-encoded first encoded image file 101 is transferred to the storage unit 4 via the control unit 3, or reproduced by the decoding unit 7 to display it on the monitor unit 8.

FIG. 2 is a detailed diagram showing an example of the first encoding unit 11 or second encoding unit 13.

A scaler unit 20 is a block for executing a resolution conversion process for input image information 100 or decoded image information 110. For example, the scaler unit executes a process of converting a moving image having horizontal 720×vertical 480 (unit: pixel) into a moving image having horizontal 352×vertical 240 (unit: pixel). An encoding processing unit 21 is a block for executing an encoding process for input image information 100, reproduced image information 110 or a scaled moving image 200. Examples of the encoding process include MPEG-2, MPEG-4, and H. 264. A multiplexing unit 22 is a block for receiving an encoded image signal 201, first encoded image file 101, or second encoded image file 102 and executing a packetizing process or a multiplexing process. Examples of multiplexing include TS (Transport Stream), PS (Program Stream) and the like.

If the editing command 112 shown in FIGS. 1, 6 and 7 is a bit rate conversion command, the editing process can be realized by reading the encoded image file 102 from the storage unit 4, executing the decoding process at the decoding unit 7, inputting the generated decoded image information 110 to the encoding processing unit 21 shown in FIG. 2 which executes the encoding process for bit rate conversion.

If the editing command 112 shown in FIGS. 1, 6 and 7 is a resolution conversion command, the editing process can be realized by reading the encoded image file 102 from the storage unit 4, executing the decoding process at the decoding unit 7, inputting the generated decoded image information 110 to the scaler unit 20 shown in FIG. 2 which executes the resolution conversion.

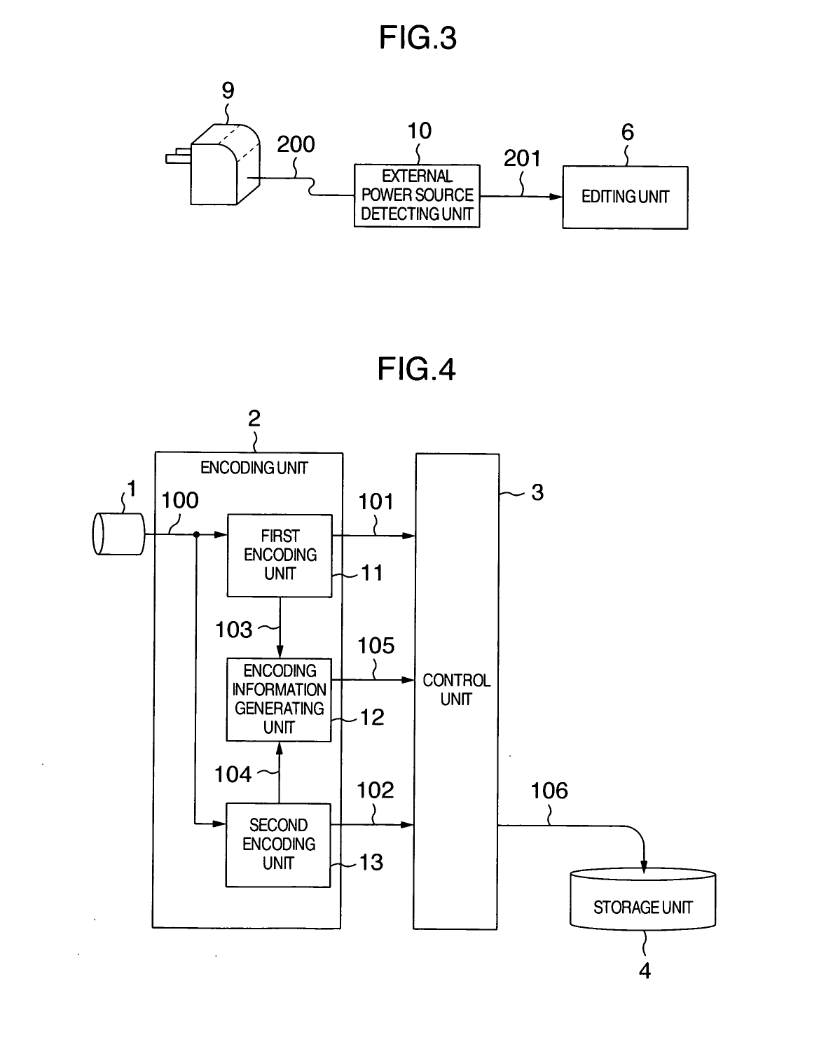

FIG. 3 shows an example of the configuration using an external battery 9 as a power source. The external battery 9 is connected to the editing unit 6 via an external power source detecting unit 10 for detecting a connection of an external power source. The external power source detecting unit 10 detects a connection of the external battery 9 and notifies the editing unit 6 of a connection. The editing unit 6 may automatically detect a connection state of an external battery to determine whether the editing process is reflected upon either the first encoded image file or the second encoded image file.

As described above, in editing an encoded image file recorded by a video camera particularly for mobile use, the editing process or the decoding process for editing is executed relative to the encoded image file having a low process load and recorded for editing, so that a consumption power for editing can be reduced. Further, the editing contents of an encoded image file for editing are generated as editing information, and the editing information on the encoded image file for storage is generated from the editing information on an encoded image file for editing, by using the correlation information representative of correlation between encoded image files for storage and editing. It is therefore possible to realize further reduction in the consumption power by reducing the editing process load of the encoded image file for storage. Furthermore, by allowing two types of encoded image files recorded at the same time to be edited at the same time, an editing efficiency of a user can be improved.

As an application example, an original image acquired by a video camera or a stand-alone image acquiring apparatus is subjected to an encoding process to obtain a second encoded image file for transfer which is transferred to a mobile device such as a portable phone. The editing process described above is executed at the portable phone and the editing contents are transmitted back to the video camera or stand-alone image acquiring apparatus, so that the original image can be edited remotely. In this case, a screen for confirming reflection of the editing process upon the original image may be displayed on a display unit.

Although the above-description has been made in connection with the embodiments, the present invention is not limited thereto. It is obvious that those skilled in the art can make various alterations and modifications without departing from the spirit and appended claims of the present invention.

1. A moving image editing system comprising:
a camera unit for acquiring a moving image and converting the moving image into a digital signal;
an encoding unit for encoding the moving image converted into said digital signal and generating a first encoded image file, a second encoded image file and correlation information of said first and second encoded image files;
a decoding unit for decoding said first encoded image file and/or said second encoded image file;
a monitor unit for displaying a moving image decoded by said decoding unit;
a user interface unit for inputting an editing command for said second encoded image file; and
an editing unit for generating editing information on said first encoded image file and/or said second encoded image file in accordance with said editing command,
wherein said editing unit generates editing information on said second encoded image file in accordance with the editing command from said user interface unit, generates editing information on said first encoded image file corresponding to the editing information on said second encoded image file in accordance with said correlation information, and executes an editing process for said first encoded image file in accordance with said editing information.

2. The moving image editing system according to claim 1, wherein said second encoded image file has a lower resolution than a resolution of said first encoded image file.

3. The moving image editing system according to claim 1, wherein said second encoded image file has a lower bit rate than a bit rate of said first encoded image file.

4. The moving image editing system according to claim 1, wherein said second encoded image file has a lower frame rate than a frame rate of said first encoded image file.

5. The moving image editing system according to claim 1, wherein said correlation information contains information on GOP start positions corresponding to said first encoded image file and said second encoded image file.

6. The moving image editing system according to claim 1, wherein said correlation information contains information on frame positions corresponding to said first encoded image file and said second encoded image file.

7. The moving image editing system according to claim 1, wherein said encoding unit and/or said decoding unit detects scene switch positions of said first encoded image file and said second encoded image file, and said correlation information contains information on scene switch positions corresponding to said first encoded image file and said second encoded image file.

8. A moving image editing apparatus comprising:
a camera unit for acquiring a moving image and converting the moving image into a digital signal;
a first encoding unit for encoding said digital signal by a first compression encoding scheme;
a second encoding unit for encoding said digital signal by a second compression encoding scheme having a lower process load than a process load of said first compression encoding scheme;
a correlation information generating unit for generating correlation information on a first encoded image file encoded by said first encoding unit and a second encoded image file encoded by said second encoding unit;
a user interface unit for inputting an editing command for said encoded image file; and
an output unit for displaying said image file on display means,
wherein said first encoded image file is subjected to an editing process in accordance with said editing command and said correlation information input from said user interface unit, on the basis of said second encoded image file from said output unit.

9. The moving image editing apparatus according to claim 8, wherein said second encoded image file has a lower resolution than a resolution of said first encoded image file.

10. The moving image editing apparatus according to claim 8, wherein said second encoded image file has a lower bit rate than a bit rate of said first encoded image file.

11. The moving image editing apparatus according to claim 8, wherein said second encoded image file has a lower frame rate than a frame rate of said first encoded image file.

12. The moving image editing apparatus according to claim 8, wherein said correlation information contains information on GOP start positions corresponding to said first encoded image file and said second encoded image file.

13. The moving image editing apparatus according to claim 8, wherein said correlation information contains information on frame positions corresponding to said first encoded image file and said second encoded image file.

14. A mobile device comprising:
in a case wherein a first image file and a second image file having a lower process load than a process load of said first image file,
a reception unit for receiving said second image file;
a display unit for displaying an image file received by said reception unit;
an editing processing unit for editing the image displayed by said display unit; and
a transmission unit for transmitting information on the image edited by said editing processing unit.

15. The mobile device according to claim 14, wherein when information on the said edited image is transmitted, a screen is displayed on said display unit to confirm that editing information is reflected upon said first image file.
